(19) United States
(12) Patent Application Publication
(10) Pub. No.: US 2013/0004807 A1
(43) Pub. Date: Jan. 3, 2013

(54) ELECTROCHEMICAL CELL HAVING RELEASABLE SUPPRESSANT

(75) Inventors: Feng Li, Troy, MI (US); Fredric C. Bonhomme, Thiensville, WI (US); Thomas M. Watson, Milwaukee, WI (US); Xugang Zhang, Milwaukee, WI (US)

(73) Assignee: JOHNSON CONTROLS TECHNOLOGY LLC, Wilmington, DE (US)

(21) Appl. No.: 13/491,490

(22) Filed: Jun. 7, 2012

Related U.S. Application Data
(60) Provisional application No. 61/494,663, filed on Jun. 8, 2011.

(51) Int. Cl. H01M 10/50

(52) U.S. Cl. 429/50; 429/62

(57) ABSTRACT

An electrochemical cell is provided. The electrochemical cell includes, but is not limited to, a can, a cell element within the can, electrolyte within the can, and a first suppressant container including suppressant and disposed within a void defined within the can. The suppressant is separated from the electrolyte by the first suppressant container.

### RELATED APPLICATIONS

The present application is related to and claims benefit under 35 U.S.C. §119(e) from U.S. Provisional Patent Application Ser. No. 61/494,663, entitled, “ELECTROCHEMICAL CELL HAVING RELEASABLE SUPPRESSANT,” filed Jun. 8, 2011, the entire contents of which are hereby incorporated by reference in their entirety to the extent permitted by law.

### FIELD OF THE DISCLOSURE

The present application relates generally to the field of batteries and battery systems and, more specifically, to batteries and battery systems that may be used in vehicle applications to provide at least a portion of the motive power for a vehicle using electric power.

### BACKGROUND OF THE INVENTION

Vehicles using electric power for all or a portion of their motive power may provide a number of advantages as compared to more traditional gas-powered vehicles using internal combustion engines. For example, vehicles using electric power may produce fewer undesirable emission products and may exhibit greater fuel efficiency as compared to vehicles using internal combustion engines (and, in some cases, such vehicles may eliminate the use of gasoline entirely, as is the case of certain types of PHEVs).

As technology continues to evolve, there is a need to provide improved power sources (e.g., battery systems or modules) for such vehicles. For example, it is desirable to increase the distance that such vehicles may travel without the need to recharge the batteries. It is also desirable to improve the performance of such batteries and to reduce the cost associated with the battery systems.

One area of improvement that continues to develop is in the area of battery chemistry. Early systems for vehicles using electric power employed nickel-metal-hydride (NiMH) batteries as a propulsion source. Over time, different additives and modifications have improved the performance, reliability, and utility of NiMH batteries.

More recently, manufacturers have begun to develop lithium-ion batteries that may be used in vehicles using electric power. There are several advantages associated with using lithium-ion batteries for vehicle applications. For example, lithium-ion batteries have a higher charge density and specific power than NiMH batteries. Stated another way, lithium-ion batteries may be smaller than NiMH batteries while storing the same amount of charge, which may allow for weight and space savings in a vehicle using electric power (or, alternatively, this feature may allow manufacturers to provide a greater amount of power for the vehicle using electric power without increasing the weight of the vehicle using electric power or the space taken up by the battery system).

It is generally known that lithium-ion batteries perform differently than NiMH batteries and may present design and engineering challenges that differ from those presented with NiMH battery technology. For example, lithium-ion batteries may be more susceptible to variations in battery temperature than comparable NiMH batteries, and thus systems may be used to regulate the temperatures of the lithium-ion batteries during vehicle operation. The manufacture of lithium-ion batteries also presents challenges unique to this battery chemistry, and new methods and systems are being developed to address such challenges.

It is also generally known that batteries and battery systems (both lithium-ion and NiMH) are subjected to various environmental and other potentially damaging conditions. For example, battery systems are sometimes provided on the exterior or underside of a vehicle using electric power, subjecting the battery systems to rain, snow, sleet and any other combination of inclement weather. Such battery systems may also be impacted by moving objects.

Batteries that are either susceptible to variations in temperature or are exposed to uncontrolled environments may also risk overheating, or being damaged by moving objects which could cause a short circuit condition and create excessive heat.

It would be desirable to provide an improved battery module and/or system for use in vehicles using electric power that addresses one or more challenges associated with NiMH and/or lithium-ion battery systems used in such vehicles. It also would be desirable to provide a battery module and/or system that includes any one or more of the advantageous features that will be apparent from a review of the present disclosure.

### SUMMARY

The present invention is defined by the following claims, and nothing in this section should be taken as a limitation on those claims.

In one aspect, an electrochemical cell is provided. The electrochemical cell includes, but is not limited to, a can, a cell element within the can, electrolyte within the can, and a first suppressant container including suppressant and disposed within a void defined within the can. The suppressant is separated from the electrolyte by the first suppressant container.

In one aspect, a method for controlling heat within an electrochemical cell is provided. The electrochemical cell has a can, a cell element, and at least one suppressant container including a suppressant and disposed within a void defined within the can. The method includes, but is not limited to, releasing suppressant from the suppressant container upon occurrence of a certain condition within or outside the can, so as to minimize the occurrence of a flame or other event associated with excessive heat and/or release of the electrolyte.

In one aspect, a battery system is provided. The battery system includes, but is not limited to, a plurality of electrochemical cells. Each electrochemical cell includes a can, a cell element within the can, electrolyte within the can, and at least one suppressant container including suppressant and disposed within a void defined within the can. The suppressant is separated from the electrolyte by the suppressant container.

### BRIEF DESCRIPTION OF THE DRAWINGS

The invention can be better understood with reference to the following drawings and description. The components in the figures are not necessarily to scale, emphasis instead being placed upon illustrating the principles of the invention.

FIG. 1 is a perspective view of a vehicle including a battery system according to an exemplary embodiment.

FIG. 2 is a cutaway schematic view of a vehicle including a battery system according to an exemplary embodiment.

FIG. 3 is a partial cutaway view of a battery system according to an exemplary embodiment.

FIG. 4 is a partial cutaway view of a battery system according to an exemplary embodiment.

FIG. 5 is a sectional view of an electrochemical cell according to an exemplary embodiment.

FIG. 6 is a sectional view of a prismatic electrochemical cell according to an exemplary embodiment.

FIG. 7 is a sectional view of a stacked, prismatic electrochemical cell according to an exemplary embodiment.

FIG. 8 is a sectional view of a sectional view of an electrochemical cell being pierced by an object according to an exemplary embodiment.

### DETAILED DESCRIPTION

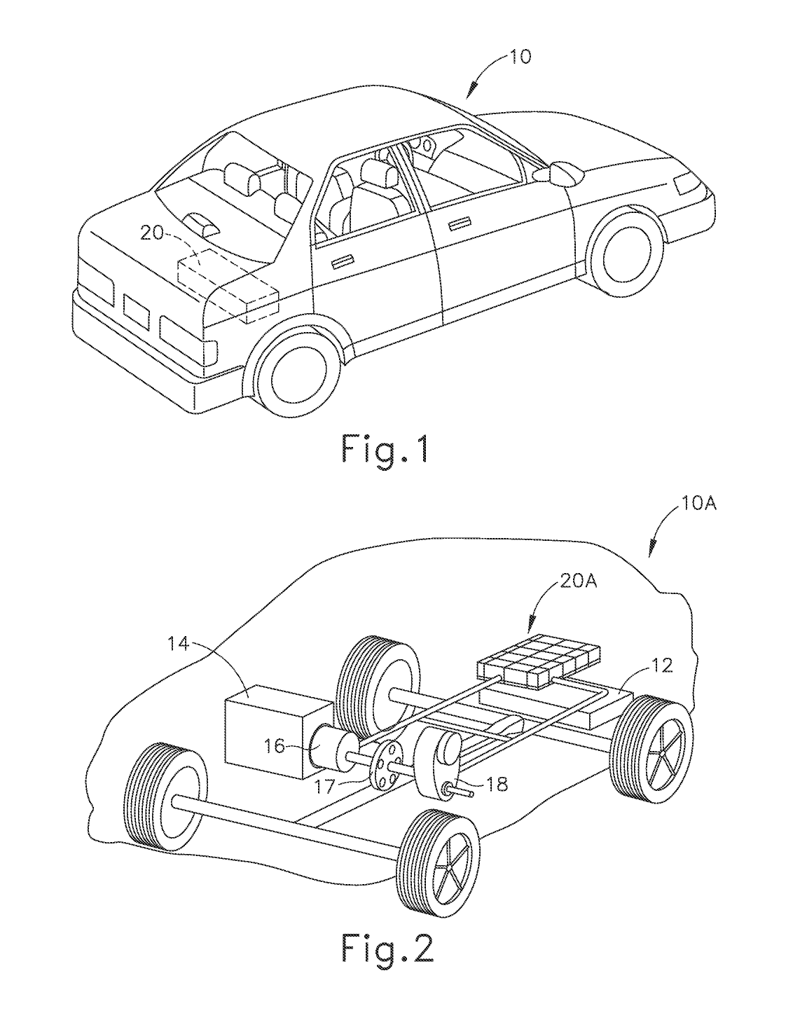

FIG. 1 is a perspective view of a vehicle 10 in the form of an automobile (e.g., a car) having a battery system 20 for providing all or a portion of the motive power for the vehicle 10.

For the purposes of the present disclosure, it should be noted that the battery modules and systems illustrated and described herein are particularly directed to applications in providing and/or storing energy in xEV electric vehicles. As will be appreciated by those skilled in the art, hybrid electric vehicles (HEVs) combine an internal combustion engine propulsion and high voltage battery power to create traction, and includes mild hybrid, medium hybrid, and full hybrid designs. A plug-in electric vehicle (PEV) is any vehicle that can be charged from an external source of electricity, such as wall sockets, and the energy stored in the rechargeable battery packs drives or contributes to drive the wheels. PEVs are a subcategory of vehicles using electric power for propulsion that include all-electric (EV) or battery electric vehicles (BEVs), plug-in hybrid vehicles (PHEVs), and electric vehicle conversions of hybrid electric vehicles and conventional internal combustion engine vehicles. The term “xEV” is defined herein to include all of the foregoing or any variations or combinations thereof that include electric power as a motive force. Additionally, although illustrated as a car in FIG. 1, the type of the vehicle 10 may be implementation-specific, and, accordingly, may differ in other embodiments, all of which are intended to fall within the scope of the present disclosure. For example, the vehicle 10 may be a truck, bus, industrial vehicle, motorcycle, recreational vehicle, boat, or any other type of vehicle that may benefit from the use of electric power for all or a portion of its propulsion power.

For the purposes of the present disclosure, it should be also noted that the battery modules and systems illustrated and described herein are also particularly directed to applications in providing and/or storing energy in stand-by power units which may be used to provide power for residential homes or businesses which typically rely on power provided from an electrical grid. A stand-by power unit can provide power which may be used as a substitute for power provided from an electrical grid, for any building or device which typically relies on power provided from an electrical grid, such as a residential home or business.

Although the battery system 20 is illustrated in FIG. 1 as being positioned in the trunk or rear of the vehicle, according to other exemplary embodiments, the location of the battery system 20 may differ. For example, the position of the battery system 20 may be selected based on the available space within a vehicle, the desired weight balance of the vehicle, the location of other components used with the battery system 20 (e.g., battery management systems, vents, or cooling devices, etc.), and a variety of other considerations.

FIG. 2 illustrates a cutaway schematic view of a vehicle 10A provided in the form of an HEV according to an exemplary embodiment. A battery system 20A is provided toward the rear of the vehicle 10A proximate a fuel tank 12 (the battery system 20A may be provided immediately adjacent the fuel tank 12 or may be provided in a separate compartment in the rear of the vehicle 10A (e.g., a trunk) or may be provided elsewhere in the vehicle 10A). An internal combustion engine 14 is provided for times when the vehicle 10A utilizes gasoline power to propel the vehicle 10A. An electric motor 16, a power split device 17, and a generator 18 are also provided as part of the vehicle drive system.

Such a vehicle 10A may be powered or driven by just the battery system 20A, by just the engine 14, or by both the battery system 20A and the engine 14. It should be noted that other types of vehicles and configurations for the vehicle drive system may be used according to other exemplary embodiments, and that the schematic illustration of FIG. 2 should not be considered to limit the scope of the subject matter described in the present application.

According to various exemplary embodiments, the size, shape, and location of the battery systems 20, 20A, the type of vehicles 10, 10A, the type of vehicle technology (e.g., HEV, PEV, EV BEV, PHEV, xEV, etc.), and the battery chemistry, among other features, may differ from those shown or described.

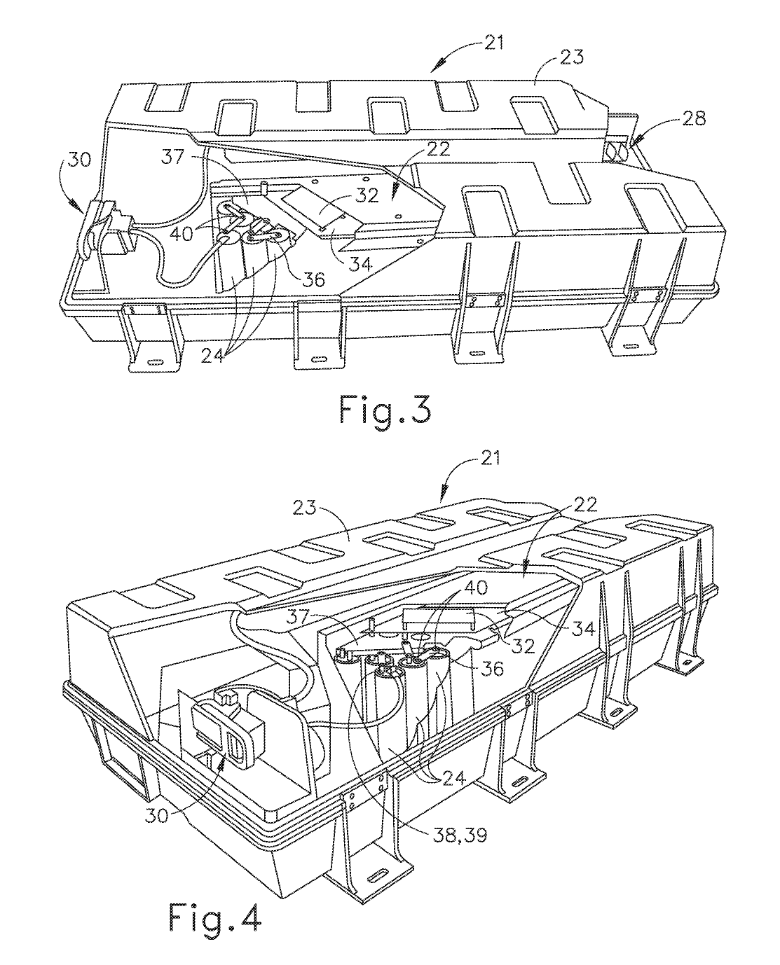

Referring now to FIGS. 3-4, partial cutaway views of a battery system 21 are shown according to an exemplary embodiment. According to an exemplary embodiment, the battery system 21 is responsible for packaging or containing electrochemical batteries or cells 24, connecting the electrochemical cells 24 to each other and/or to other components of the vehicle electrical system, and regulating the electrochemical cells 24 and other features of the battery system 21. For example, the battery system 21 may include features that are responsible for monitoring and controlling the electrical performance of the battery system 21, managing the thermal behavior of the battery system 21, containing and/or routing of effluent (e.g., gases that may be vented from a cell 24), and other aspects of the battery system 21.

According to the exemplary embodiment as shown in FIGS. 3-4, the battery system 21 includes a cover or housing 23 that encloses the components of the battery system 21. Included in the battery system are two battery modules 22 located side-by-side inside the housing 23. According to other exemplary embodiments, a different number of battery modules 22 may be included in the battery system 21, depending on the desired power and other characteristics of the battery system 21. According to other exemplary embodiments, the battery modules 22 may be located in a configuration other than side-by-side (e.g., end-to-end, etc.).

As shown in FIGS. 3-4, the battery system 21 also includes a high voltage connector 28 located at one end of the battery system 21 and a service disconnect 30 located at a second end of the battery system 21 opposite the first end according to an exemplary embodiment. The high voltage connector 28 connects the battery system 21 to a vehicle 10. The service disconnect 30, when actuated by a user, disconnects the two individual battery modules 22 from one another, thus lowering the overall voltage potential of the battery system 21 by half to allow the user to service the battery system 21.

According to an exemplary embodiment, each battery module 22 includes a plurality of cell supervisory controllers (CSCs) 32 to monitor and regulate the electrochemical cells 24 as needed. According to other various exemplary embodiments, the number of CSCs 32 may differ. The CSCs 32 are mounted on a member shown as a trace board 34 (e.g., a printed circuit board). The trace board 34 includes the necessary wiring to connect the CSCs 32 to the individual electrochemical cells 24 and to connect the CSCs 32 to the battery management system (not shown) of the battery system 21. The trace board 34 also includes various connectors to make these connections possible (e.g., temperature connectors, electrical connectors, voltage connectors, etc.).

Still referring to FIGS. 3-4, each of the battery modules 22 includes a plurality of electrochemical cells 24 (e.g., lithium-ion cells, nickel-metal-hydride cells, lithium polymer cells, etc., or other types of electrochemical cells now known or hereafter developed). According to an exemplary embodiment, the electrochemical cells 24 are generally cylindrical lithium-ion cells configured to store an electrical charge. According to other exemplary embodiments, the electrochemical cells 24 could have other physical configurations (e.g., oval, prismatic, polygonal, etc.). The capacity, size, design, and other features of the electrochemical cells 24 may also differ from those shown according to other exemplary embodiments.

Each of the electrochemical cells 24 are electrically coupled to one or more other electrochemical cells 24 or other components of the battery system 21 using connectors provided in the form of bus bars 36 or similar elements. According to an exemplary embodiment, the bus bars 36 are housed or contained in bus bar holders 37. According to an exemplary embodiment, the bus bars 36 are constructed from a conductive material such as copper (or copper alloy), aluminum (or aluminum alloy), or other suitable material. According to an exemplary embodiment, the bus bars 36 may be coupled to terminals 38, 39 of the electrochemical cells 24 by welding (e.g., resistance welding) or through the use of fasteners 40 (e.g., a bolt or screw may be received in a hole at an end of the bus bar 36 and screwed into a threaded hole in the terminal 38, 39).

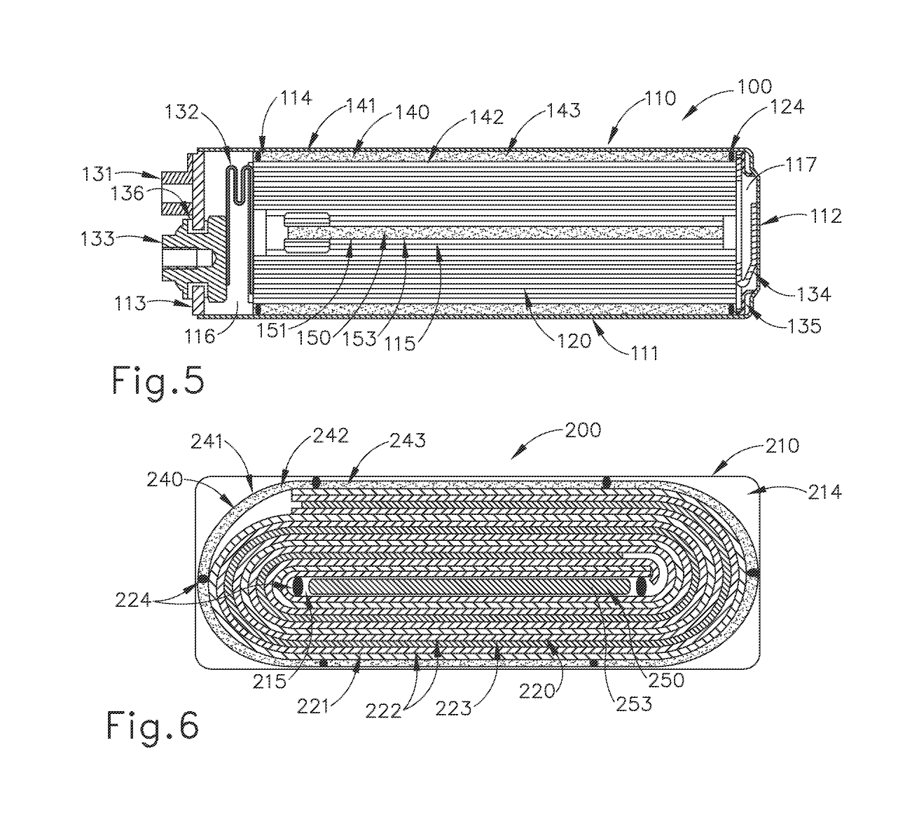

Referring to FIG. 5, a side sectional view of an electrochemical cell 100 is shown. The electrochemical cell 100 is provided according to one exemplary embodiment. The electrochemical cell 100 generally includes a can or housing 110, a cell element 120, terminals 131 and 133, one or more suppressant containers or safety bags 140 and 150, and an electrolyte.

In one exemplary embodiment, the can 110 comprises a cylindrical wall 111 that is coupled to first and second end walls 112, 113 disposed at opposing ends of the can 110. The cell element 120 comprises a negative electrode (i.e., anode), separator, and a positive electrode (i.e., cathode). The electrodes and separator are wound around a mandrel to form the cell element 120. The cell element 120 and electrolyte are provided within the can 110 between the first and second end walls 112, 113.

In one exemplary embodiment, spacers 124 are disposed between the cylindrical wall 111 of the can 110 and the outside of the cell element 120. The spacers 124 create and/or maintain spacing between the cylindrical wall 111 and the cell element 120, thus defining an exterior void 114 (e.g., space, area, cavity, hollow, gap, etc.) within the can 110. More particularly, the spacers 124 define voids 114 sufficient for containing suppressant containers 140. According to other exemplary embodiment, the spacer may be otherwise configured according to size, shape, and/or location to define one or more voids for containing one or more suppressant containers 140. In still other embodiments, spacers are not used.

In an exemplary embodiment, the spacers 124 are made from an inert material that generally will not react with other contents in the can 110 of the electrochemical cell 100. Preferably, the spacers are made from Teflon. However, those skilled in the art will recognize that other, generally inert materials may be used. Spacer material may also be chosen such that throughout the electrochemical cell's 100 useful life, the spacers 124 will generally maintain their general physical characteristics, including size, shape, and/or elasticity to help maintain the voids 114. The spacer material may also electrically insulate the cell element 120 from the can 110.

In another exemplary embodiment, the spacers 124 disposed in the exterior void 114 are ring-shaped and configured to surround the cell element 120 within the can 110. However, those skilled in the art will recognize that the spacers 124 may be of any shape, size, and arrangement sufficient to create and/or maintain spacing between the cell element 120 and can 110.

According to another exemplary embodiment, the mandrel, around which the electrodes are wound to form the cell element 120, includes a hollow portion that defines an interior void 115 (e.g., space, area, cavity, hollow, gap, etc.) within the can 110. The interior void 115 is configured such that a suppressant container 150 may be disposed within. Spacers (such as, e.g., spacers 124) may be used in combination with the hollow mandrel to help define the interior void 115.

In one exemplary embodiment, a negative terminal 133 is electrically coupled to the negative electrode by way of a first connection strip or current collector 132, and a positive terminal 131 is coupled to the positive electrode by way of a second connection strip 134. The terminals 131, 133 are configured to provide external connection points through which electrical energy may be transferred to and from the electrochemical cell 100. For example, the positive electrode may be coupled to first end wall 112, which in turn is coupled to the positive terminal 131 via the can 110 and second end wall 113. The negative terminal 133 may pass through the second end wall 113 being electrically insulated from the end wall 113 by a gasket 136. Another gasket 135 insulates the positive electrode from end wall 113. Those skilled in the art will recognize that alternative terminal configurations may be utilized. For example, terminals may be disposed on opposite sides of the can, multiple terminals may be coupled to each electrode, or terminals may have different shapes.

According to one exemplary embodiment, the electrochemical cell 100 contains an outer suppressant container 140 disposed in the exterior void 114 between the can 110 and cell element 120. The electrochemical cell 100 may also contain an inner suppressant container 150 disposed in the interior void 115 between interior portions of the cell element 120. Each of the suppressant containers 140, 150 contains a suppressant (e.g., a fire or flame retardant, or other heat suppressant) 143, 153 and is configured to release the suppressant 143, 153 upon the occurrence of certain conditions within the electrochemical cell 100 or events originating outside the electrochemical cell 100. According to other exemplary embodiments, the electrochemical cell 100 may additionally, or instead, include suppressant containers disposed in other interior voids within the can 110 of the electrochemical cell 120. For example, an interior void 116 may be located between the second end wall 113 and the cell element 120, and an interior void 117 may be located between the first end wall 112 and the cell element 120.

According to an exemplary embodiment, the suppressant 143, 153 is a material or chemical that behaves as a flame inhibitor or otherwise limits heat propagation. For example, the suppressant 143, 153 may, in a physical char-forming process, build up an isolating layer between condensed and gas phases to stop combustion and/or may, in a chemical radical-scavenging process, terminate radical chain reactions of combustion. As an example, dimethyl methyl phosphonate (DMMP) is believed to be a good free radical inhibitor that captures H• and HO• in the flame zone to weaken or terminate combustion chain branching reactions. According to other exemplary embodiments, the suppressant 143, 153 may effectively suppress flames or heat propagation by other means or mechanism. According to still other exemplary embodiments, the suppressant may be 2,4,6-tribromophenol, dibromomethane, tris(2-chloroethyl)phosphate, triphenylphosphate (TPP), diphenyl phosphate, tris(2,2,2-tribluoroethyle) phosphate, chloroacetyl chloride, tribromoethanol, cyclophosphazene, tris(2,2,2-trifluoroethyl)phosphate (TFP), trimethyl phosphate (TMP), triethyle phosphate (TEP), an organic phosphorous compound or its halogenated derivatives, other flame retardant compounds, or combinations thereof (e.g., based on cost, relative boiling point, etc.). In one exemplary embodiment, the suppressant 143, 153 includes a mixture of materials (i.e. a low boiling point material and a high boiling point material) have two or more boiling points. Preferably, the low boiling point material helps to release the suppressant 143, 153 to the electrolyte and volatilize with a low boiling point electrolyte when the temperature of the electrochemical cell 24 is 130° C. or more. Preferably, the high boiling point material helps to release the suppressant 143, 153 to the electrolyte and volatilize with a high boiling point electrolyte when the temperature of the electrochemical cell 24 is 180° C. or more. The boiling points of the mixture of materials within the suppressant 143, 153 may range from 130° C. to 300° C.

In one exemplary embodiment, the outer suppressant container 140 comprises an inner sheet 142 disposed proximate to the cell element 120 and an outer sheet 141 disposed proximate to the cylindrical wall 111 of the can 110. The inner sheet 142 and outer sheet 141 are coupled together to create a sealed cavity for containing the suppressant 143.

In one exemplary embodiment, the outer suppressant container 140 is configured to release the suppressant 143 upon occurrence of certain conditions, such as an internal event within the can 110. During normal operation, such as between approximately −30 and 60 degrees C., the suppressant container 140 has sealing properties and mechanical strength sufficient to contain the suppressant 140 without leaking. For example, the inner sheet 142 may have a lower melting point and lower tensile strength than the outer sheet 141. The inner sheet 142 may have a melting point of about 120-130 degrees C., and the outer sheet 141 may have a melting point of about 160 degrees C. Configured in this manner, the inner sheet 141 may melt before the outer sheet 141 when the interior of the electrochemical cell 100 reaches certain temperatures. When the inner sheet 142 of the outer suppressant container 140 melts, the suppressant 143 is released and mixes with the electrolyte contained in the can 110, such as by diffusion or dynamic flow as the suppressant 143 exits the suppressant container 140.

In one exemplary embodiment, the outer suppressant container 140 is configured to release the suppressant 143 upon occurrence of certain conditions, such as an external event affecting the can 110. For example, if the can 110 is pierced or deforms (e.g., during a vehicle accident), the outer sheet 141 may rupture and release the suppressant 143 to mix with the electrolyte.

In one exemplary embodiment, the outer suppressant container 140 extends substantially the entire length of the cell element 120. The outer suppressant container 140 may also wrap around substantially all the periphery of the cell element 120. However, those skilled in the art will recognize that other configurations of the suppressant container are possible, including, for example, providing a smaller outer suppressant container 140 that extends less than the entire length of the cell element 120 or wraps around less than all of the cell element 120, providing multiple smaller outer suppressant containers that cover substantially all of the cell element 120 or less than all of the cell element 120, or providing multiple layered outer suppressant containers 140.

In one exemplary embodiment, the materials used for the suppressant container 140 are generally inert and will not react with the other contents of the electrochemical cell 100. Preferably, the suppressant container 140 consists generally of inert materials, and preferably consists of at least 50%, and preferably of at least 75%, inert materials. For example, the inner sheet 142 of the outer suppressant container 140 may be a low density polyethylene material approximately 1-2 mil thick having similar melting characteristics as the separator. The outer sheet 141 may be a polypropylene material approximately 1-2 mil thick, or aluminum laminate material. According to other exemplary embodiments, the suppressant container 140 may be a polyethylene, a polymer, a copolymer, or an aluminum laminate material.

Those skilled in the art will recognize that different bag configurations, materials, and thicknesses may be chosen depending on desired characteristics. For example, with materials with a lower or higher melting temperature may be used for the inner sheet 142 and sheet 151.

In one exemplary embodiment, the outer suppressant container 140 is manufactured by coupling the inner sheet 142 to the outer sheet 141 at their respective peripheries (e.g., outside edge). In other embodiments, the outer suppressant container 140 may be manufactured by folding over a single sheet 141 and sealing at its ends and edge, or by sealing an extruded tube at its ends. This may be accomplished, for example, by heat sealing, ultrasonic welding, laminating, or any other method sufficient to couple the inner sheet 142 to the outer sheet 141 and prevent leakage of the suppressant 143 from the outer suppressant container 140.

In one exemplary embodiment, the outer suppressant container 140 has a total thickness of approximately 1 mm to 2 mm and contains approximately 6 grams of the suppressant 143. However, those skilled in the art will recognize that the outer suppressant container 140 may be thinner or thicker and may contain more or less suppressant 143.

In yet other embodiments, the outer suppressant container 140 contains approximately 15% suppressant 143 by weight as compared to the electrolyte contained in the electrochemical cell 100. In still other embodiments, the outer suppressant container 140 contains between approximately 1% and 15% suppressant 143 by weight. Those skilled in the art will recognize that other amounts of suppressant 143 may be provided, whether measured in an absolute amount or relative to the electrolyte. Further, those skilled in the art will recognize that, depending on the suppressant used, providing more suppressant may increase the electrochemical cell's 100 fire retarding ability and overall safety of the electrochemical cell 100.

In another exemplary embodiment, the electrochemical cell 100 may contain an inner suppressant container 150 used by itself or in conjunction with the outer suppressant container 140. The inner suppressant container 150 containing the suppressant 153 is disposed in the interior void 115 between inner portions of the cell element 120 (e.g., hollow portion of the mandrel).

In one exemplary embodiment, the inner suppressant container 150 is configured to release the suppressant 153 upon occurrence of certain conditions within the can 110. For example, the sheet 151 may have a melting point of about 120-130 degrees C. Configured in this manner, the sheet 151 will melt when the electrochemical cell reaches those temperatures and will release the suppressant 153 to mix with the electrolyte.

In one exemplary embodiment, the inner suppressant container 150 extends substantially the entire length of the cell element 120. However, those skilled in the art will recognize that other configurations of the inner suppressant container 150 are possible, including, for example, providing a smaller inner suppressant container 150 that extends less than the entire length of the cell element 120, or providing multiple inner suppressant containers 150.

In one exemplary embodiment, the inner suppressant container 150 comprises one sheet 151 that is disposed proximate the interior portions of the cell element 120. The sheet 151 is folded over and coupled to itself to create a sealed cavity 154 for containing suppressant 153. The inner suppressant container 150 may instead comprise an extruded tube sealed at its ends.

In one exemplary embodiment, the suppressant containers 140, 150 may be filled, for example, by funneling or otherwise injecting the suppressant 143, 153 into the suppressant containers 140, 150 and then sealing the suppressant containers 140, 150.

In one exemplary embodiment, the inner suppressant container 150 is made from an inert material, such as polypropylene or polyethylene. Those skilled in the art will recognize that materials, configurations, and manufacturing methods may be chosen according to desired characteristics, such as melting temperature, melting time, void size and shape, or cell chemistry.

According to one exemplary embodiment, the electrochemical cell 100 is assembled by winding the negative and positive electrodes into the cell element 120, and current collectors are welded to the cell element. The suppressant containers 140, 150 are formed and filled with the suppressant 143, 153. The cell element 120 is then placed in the can 110. The positive current collector is welded to the first end wall 112, and the negative current collector is welded to the negative terminal. The second end wall or cover 113 is welded to the can 110. Finally, the can 110 is filled with electrolyte through a fill hole, which is later plugged. Those skilled in the art will recognize that assembly of the electrochemical cell 100 may be accomplished in different manners.

A particular advantage of the suppressant containers 140, 150 is that the suppressant 143, 153 is separate from the electrolyte during normal operation of the electrochemical cell 100. This provides improved performance over electrochemical cells having electrolytes premixed with a suppressant. Further, other suppressants may be used regardless of their electrochemical performance. Suppressants may be chosen instead based on cost, quality, availability, cell chemistry, or environmental concerns, for example, rather than electrochemical performance. Moreover, these advantages are provided with modest increases to the size and mass of the electrochemical cell 100. For example, the addition of 1 mm thick outer suppressant container 140 increases the outer diameter of the electrochemical cell 100 by only 2 mm.

Referring now to FIG. 6, a sectional view of a prismatic electrochemical cell 200 is shown according to another exemplary embodiment. The electrochemical cell 200 includes a prismatic can 210, cell element 220, exterior and interior suppressant containers 240 and 250, and an electrolyte. The cell element 220 comprises a negative electrode 221, a separator 222, and a positive electrode 223, which are generally layered together and wound to form the cell element 220. The cell element 220 is disposed within the can 210.

According to an exemplary embodiment, spacers 224 are disposed at the top and bottom of the cell element 220 to create and/or maintain spacing between the can 210 and cell element 220, thereby defining an outer void 214. The can 210 may have generally pointed corners (as shown) to define the outer void 214, or the can may have a more contoured profile that more closely follows the outer periphery of the cell element 220. Spacers 224 may additionally be disposed between interior portions of the cell element 220, thereby defining an interior void 215. The spacers 224 are configured of material, shape, size, and placement to define exterior and interior voids 214, 215 to contain exterior and interior suppressant containers 240, 250. The suppressant container 240 comprises an inner sheet 242 and an outer sheet 241. Preferably, in one embodiment, the inner sheet 242 includes a low boiling point material or a high boiling point material, and the outer sheet 241 includes a low boiling point material or a high boiling point material.

According to one exemplary embodiment, the exterior and interior suppressant containers 240, 250 contain suppressant 243, 253. The suppressant containers 240, 250 are configured to release the suppressant 243, 253 into the can 210 to mix with the electrolyte as described above.

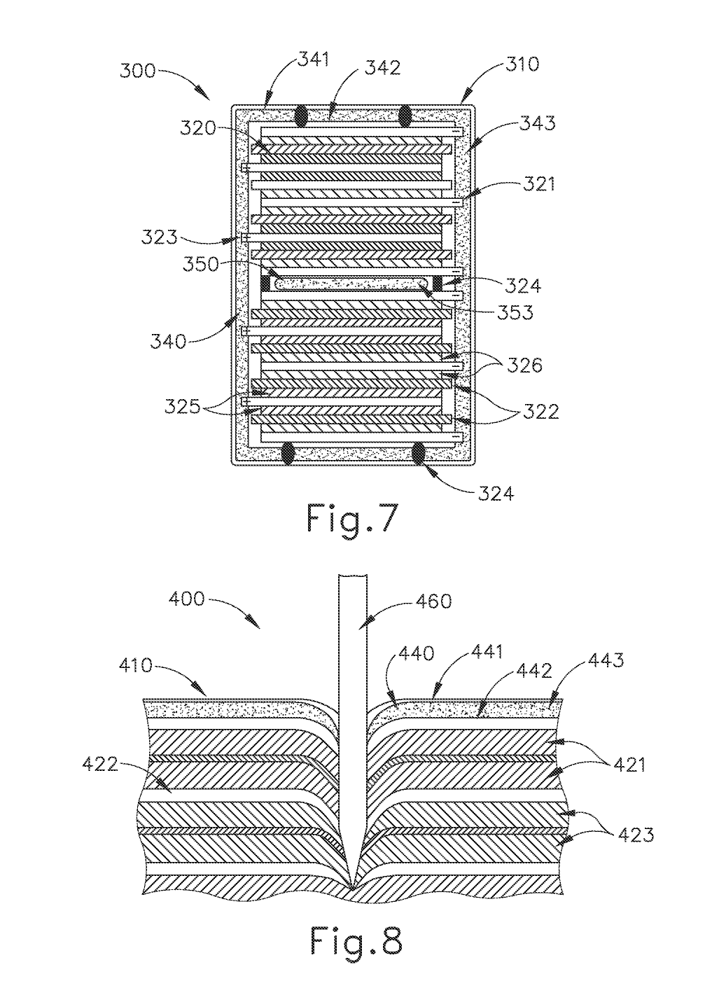

Referring now to FIG. 7, the electrochemical cell may be a prismatic stacked type cell 300 according to another exemplary embodiment. The electrochemical cell 300 includes a container 310, cell element 320, a suppressant container 340, and an electrolyte. The cell element 320 comprises alternating layers of negative electrodes 321, separator 322, and positive electrodes 323. A first set of active layers 325 are disposed on either side of the positive electrodes 323, a second set of active layers 326 are disposed on either side of each of the negative electrodes 321.

According to an exemplary embodiment, spacers 324 are disposed between the cell element 320 and the container 310 to create and/or maintain spacing between the container 310 and cell element 320. The spacers 324 are configured of material, shape, size, and placement to define an exterior void 324 to contain a suppressant container 340. In another embodiment, the cell element 320 may be divided into first and second portions separated by spacers 324, which define an inner void 315. An inner suppressant container 350 containing suppressant 353 may be disposed in the inner void 315 between the first and second portions of the cell element 320. According to one exemplary embodiment, the suppressant containers 340, 350 contain suppressant 343, 353. The suppressant containers 340, 350 are configured to release the suppressant 343, 353 into the container 310 and mix with the electrolyte in the manners described above.

Referring now to FIG. 8, a sectional view of an electrochemical cell 400 according to an exemplary embodiment is shown being pierced by an object shown as a nail 460. The nail 460 is shown penetrating the can 410, safety bag or suppressant container 440, negative electrode 421, separator 422, and positive electrode 423. When the nail 460 penetrates the suppressant container 440, it ruptures the outer sheet 441 and inner sheet 442, so as to release the suppressant 443 into the can 410 to mix with the electrolyte. Mixing of the suppressant 443 with the electrolyte helps to suppress or inhibit the likelihood of a flame.

Those skilled in the art will recognize that the features disclosed in the embodiments described above may also be incorporated with different electrochemical cell configurations. For example, the features may be applied to electrochemical cells having different configurations or chemistry and/or cells used individually or as part of a larger system.

As utilized herein, the terms “approximately,” “about,” “substantially,” and similar terms are intended to have a broad meaning in harmony with the common and accepted usage by those of ordinary skill in the art to which the subject matter of this disclosure pertains, and in one non-limiting embodiment the terms are defined to be within 10%, in another embodiment within 5%, in another embodiment within 1% and in another embodiment within 0.5%. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the electrochemical cell having releasable suppressant as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

1. An electrochemical cell comprising:
a can;
a cell element within the can;
electrolyte within the can; and
a first suppressant container including suppressant and disposed within a void defined within the can, wherein the suppressant is separated from the electrolyte by the first suppressant container.

2. The electrochemical cell of claim 1 further comprising spacers disposed between the can and the cell element and defining a void where the first suppressant container is disposed.

3. The electrochemical cell of claim 2 further comprising a second suppressant container located in a void within interior portions of the cell element.

4. The electrochemical cell of claim 3, wherein the second suppressant container is located in an interior void of a mandrel around which electrodes are wound to form the cell element.

5. The electrochemical cell of claim 1, wherein the electrochemical cell is a lithium-ion cell, a nickel-metal-hydride cell, or a lithium polymer cell.

6. The electrochemical cell of claim 1, wherein the first suppressant container extends substantially the entire length of the cell element.

7. The electrochemical cell of claim 1, wherein first suppressant container wraps around substantially all the periphery of the cell element.

8. The electrochemical cell of claim 1, wherein the first suppressant container consists essentially of inert materials.

9. A method for controlling heat within an electrochemical cell, the electrochemical cell having a can, a cell element, and at least one suppressant container including a suppressant and disposed within a void defined within the can, the method comprises:
releasing suppressant from the suppressant container upon occurrence of a certain condition within or outside the can, so as to minimize the occurrence of a flame or other event associated with excessive heat and/or release of the electrolyte.

10. The method of claim 9, wherein the certain condition is an external event affecting the can.

11. The method of claim 9, wherein the certain condition is an internal event within the can.

12. The method of claim 9, wherein the suppressant is a fire retardant, a flame retardant, a heat suppressant, or a flame inhibitor.

13. The method of claim 9, wherein the suppressant includes a mixture of materials have two or more boiling points, wherein the boiling points range from 130° C. to 300° C.

14. The method of claim 9, wherein the suppressant container comprises an inner sheet disposed proximate to the cell element and an outer sheet disposed proximate to a wall of the can, wherein the inner sheet and the outer sheet are coupled together to create a sealed cavity for containing the suppressant.

15. The method of claim 14, wherein the inner sheet has a melting point which is less than the outer sheet.

16. A battery system comprising:
a plurality of electrochemical cells, wherein each electrochemical cell includes a can, a cell element within the can, electrolyte within the can, and at least one suppressant container including suppressant and disposed within a void defined within the can, wherein the suppressant is separated from the electrolyte by the suppressant container.

17. An xEV vehicle comprising the battery system of claim 16, wherein the battery system provides all or a portion of the motive power for the vehicle.

18. The battery system of claim 16, wherein the suppressant container comprises an inner sheet disposed proximate to the cell element and an outer sheet disposed proximate to a wall of the can, wherein the inner sheet and the outer sheet are coupled together to create a sealed cavity for containing the suppressant.

19. The battery system of claim 16, wherein each electrochemical cell includes an outer suppressant container disposed between the can and the cell element and an inner suppressant container located in a void within interior portions of the cell element.

20. The battery system of claim 16, wherein each electrochemical cell is a lithium-ion cell, a nickel-metal-hydride cell, or a lithium polymer cell.

21. The battery system of claim 16, wherein the suppressant container extends substantially the entire length of the cell element.

22. A standby power unit comprising the battery system of claim 16, wherein the standby power unit provides power which may be used as a substitute for power provided from an electrical grid.
